(19) United States
(12) Patent Application Publication
(10) Pub. No.: US 2003/0046083 A1
(43) Pub. Date: Mar. 6, 2003

(54) USER VALIDATION FOR INFORMATION SYSTEM ACCESS AND TRANSACTION PROCESSING

(76) Inventors: EDWARD J. DEVINNEY JR., DELANCO, NJ (US); MANISH SHARMA, SOMERSET, NJ (US); CHRIS KEYSER, ROEBLING, NJ (US); RAINER ROTHACKER, CLIFFWOOD BEACH, NJ (US); RICHARD J. MAMMONE, BRIDGEWATER, NJ (US)

Correspondence Address: Thomas H. Young, Esq., Merchant & Gould, P.C., 3200 IDS Center, 80 South Eighth Street, Minneapolis, MN, 55402-2215, US

(21) Appl. No.: 08/976,279

(22) Filed: Nov. 21, 1997

Related U.S. Application Data
(60) Provisional application No. 60/031,638, filed on Nov. 22, 1996.

(51) Int. Cl. G10L 21/00

(52) U.S. Cl. 704/273

(57) ABSTRACT

The present invention applies speech recognition technology to remote access, verification, and identification applications. Speech recognition is used to raise the security level of many types of transaction systems which previously had serious safety drawbacks, including: point of sale systems, home authorization systems, systems for establishing a call to a called party (including prison telephone systems), internet access systems, web site access systems, systems for obtaining access to protected computer networks, systems for accessing a restricted hyperlink, desktop computer security systems, and systems for gaining access to a networked server. A general speech recognition system using communication is also presented. Further, different types of speech recognition methodologies are useful with the present invention, such as “simple” security methods and systems, multi-tiered security methods and systems, conditional multi-tiered security methods and systems, and randomly prompted voice token methods and systems.

### CROSS REFERENCE TO RELATED APPLICATIONS

This application claims priority from U.S. Provisional Application Ser. No. 60/031,638, Filed Nov. 22, 1996, entitled “User Validation For Information System Access And Transaction Processing.”

### BACKGROUND OF THE INVENTION

The invention is a verification system for ensuring that transactions are completed securely. The invention uses the principle of speaker recognition to allow a user to complete a transaction.

1. Field of the Invention

The invention relates to the fields of signal processing, communications, speaker recognition and security, and secure transactions.

2. Description of Related Art

With the increased use of credit card and computer related transactions security of the transactions is a reoccurring problem of increasing concern. Conventional approaches for credit card validation have included reading a magnetic strip of the credit card at a point of sale. Information stored on the credit card, such as account information, is forwarded over a telephone connection to a credit verification service at the credit card company. For example, an X.25 connection to the credit verification system has been used. A response from the credit verification service indicates to the salesperson whether the customer's credit card is valid and whether the customer has sufficient credit. An example of the above-described system is manufactured by VeriFone® of Redwood City, Calif., U.S.A.. These prior art systems, however, have the disadvantage that the credit card may be verified as valid and as having sufficient credit even if it is used by someone who is not authorized to use the credit card.

The identity of the consumer who presents a credit card is manually verified by a merchant. The back of the credit card contains a signature strip, which the consumer signs upon credit card issuance. The actual signature of the consumer at the time of sale is compared to the signature on the back of the credit card by the merchant. If in the merchant's judgement, the signatures match, the transaction is allowed to proceed.

Other systems of the prior art include placing photographs of authorized users on the credit card. At the time of the transaction, the merchant compares the photograph on the card with the face of the person presenting the card. If there appears to be a match, the transaction is allowed to proceed.

While signatures and photographs are personal characteristics of the user, they have not been very effective. Signatures are relatively easy to forge and differences between signatures and photographs may go unnoticed by inattentive merchants. These systems are manual and consequently prone to human error. Further, these systems cannot be used with credit card transactions which do not occur in person, i.e., which occur via telephone.

Computer related applications, such as accessing systems, local area networks, databases and computer network (such as “Internet”) systems, have conventionally used passwords (known as personal identification numbers—“PINs”) entered from a keyboard as a security method for accessing information. Computer passwords have the shortcoming of being capable of being stolen, intercepted or re-created by third parties. Computer programs exist for guessing (“hacking”) passwords. Additionally, computer passwords/PINs are not personal characteristics, which means that they are less complex and easier to generate by a third party with no knowledge of the authorized individual's personal characteristics.

With the advent of electronic commerce on the internet, goods and services are increasingly being purchased by consumers, who submit credit card or other “secure” information to merchants over the internet. Transactions initiated from users connected to the internet currently have limited security provisions. For example, a retail provider receiving a user's credit card number from the internet has no idea whether the person providing the number is authorized to use the credit card, or has obtained a credit card number from an illegal source.

As computers play a greater and more critical role in everyday life, security has emerged as a significant concern. Whether it's restricting children from playing with their parent's tax return (local access), protecting against an employee stealing trade secrets (network access), or limiting access to a value added WEB site (remote network access), the ability to determine that the claimed user is the real user is absolutely necessary.

Additional areas in which a need for heightened security exists are cellular telephone systems and prison telephone systems. In cellular systems, fraud from unauthorized calling is a recurring problem. In prison systems, the identity of inmates must be closely monitored, for purpose of authorizing certain transactions, such as telephone calls.

What is needed are local and remote secure access systems and methods using personal characteristics of users for identifying and/or verifying the users.

### SUMMARY OF THE INVENTION

The present invention is an improved method and system for increasing the security of credit card transactions, prison inmate transactions, database access requests, internet transactions, and other transaction processing applications in which high security is necessary. According to the present invention, voice print and speaker recognition technology are used to validate a transaction or identify a user.

Within speaker recognition (also referred to as voice recognition herein), there exists two main areas: speaker identification and speaker verification. A speaker identification system attempts to determine the identity of a person within a known group of people using a sample of his or her voice. Speaker identification can be accomplished by comparing a voice sample of the user in question to a database of voice data, and selecting the closest match in the database. In contrast, a speaker verification system attempts to determine if a person's claimed identity (whom the person claims to be) is valid using a sample of his or her voice. Speaker verification systems are informed of the person's claimed identity by index information, such as the person's claimed name, credit card number, or social security number. Therefore, speaker verification systems typically compare the voice of the user in question to one set of voice data stored in a database, the set of voice data identified by the index information.

Speaker recognition provides an advantage over other security measures such as passwords (including personal identification numbers) and personal information, because a person's voice is a personal characteristic uniquely tied to his or her identity. Speaker verification therefore provides a robust method for security enhancement.

Speaker verification consists of determining whether or not a speech sample provides a sufficient match to a claimed identity. The speech sample can be text dependent or text independent. Text dependent speaker verification systems identify the speaker after the utterance of a password phrase. The password phrase is chosen during enrollment and the same password is used in subsequent verification. Typically, the password phrase is constrained within a specific vocabulary (i.e. number of digits). A text independent speaker verification system does not use any pre-defined password phrases. However, the computational complexity of text-independent speaker verification is much higher than that of text dependent speaker verification systems, because of the unlimited vocabulary.

The present invention uses speech biometrics as a natural interface to authenticate users in today's multi-media networked environment, rather than a password that can be easily compromised.

In accordance with the present invention, security can be incorporated in at least three access levels: at the desktop, on corporate network servers (NT, NOVELL, or UNIX), and at a WEB server (internets/intranets/extranet). The security mechanisms may control access to a work station, to network file servers, to a web site, or may secure a specific transaction. Nesting of these security levels can provide additional security; for instance, a company could choose to have it's work stations secured locally by a desktop security mechanism, as well as protect corporate data on a file server with a NT, NOVELL or FTP server security mechanism.

Use of speaker recognition, and therefore voice biometric data, is able to provide varying levels of security based upon customer requirements. A biometric confirms the actual identity of the user; other prevalent high security methods, such as token cards, can still be compromised if the token card is stolen from the owner. A system can employ any of these methods at any access level. In all cases of the inventive methods described herein, the user must know an additional identifying piece of information. The security system is not compromised whether this information is publicly obtainable information, such as their name, or a private piece of information, such as a PIN, a social security number, or an account number.

In accordance with the present invention, “simple” security systems and methods (single spoken password), multi-tiered security systems (multiple tiers of spoken passwords) and randomly prompted voice tokens (prompting of words obtained through a random look-up) are provided for improved security. These security systems and methods may be used to increase the security of point of sale systems, home authorization systems, systems for establishing a call to a called party (including prison telephone systems), internet access systems, web site access systems, systems for obtaining access to protected computer networks, systems for accessing a restricted hyperlink, desktop computer security systems, and systems for gaining access to a networked server.

### BRIEF DESCRIPTION OF THE DRAWINGS

FIG. 1 is a diagram of a speech recognition unit.

FIG. 2 is a high level representation of the unit shown in FIG. 1.

FIG. 3 shows a “simple” security method and system.

FIG. 4A shows a diagram of a multi-tiered security method and system.

FIG. 4B shows a diagram of a multi-tiered security method and system with conditional tiers.

FIG. 4C shows a diagram of a randomly prompted voice token method and system.

FIG. 5A shows a schematic diagram of the general configuration of a speaker verification method and system.

FIG. 5B shows a more specific schematic of the FIG. 5A method and system.

FIG. 6 is a schematic diagram of a speaker recognition method and system for a point of sale system.

FIG. 7 is a schematic diagram of an embodiment where home authorization is obtained through a call center.

FIG. 8 is a schematic diagram of an embodiment for establishing a call to a called party using speaker recognition.

FIG. 9 is a schematic diagram of an embodiment for use in establishing an internet connection using speaker recognition.

FIG. 10A is a schematic diagram of an embodiment for use in establishing a connection to a web site using speaker recognition.

FIG. 10B is a schematic diagram of an embodiment for use in establishing a connection to a protected network using speaker recognition.

FIG. 10C is a schematic diagram of an embodiment for use in establishing a connection to a restricted hyperlink on a web server using speaker recognition.

FIG. 11 shows an embodiment for use in securing a desktop computer using speaker recognition.

FIG. 12A shows a system for use in gaining access to a networked server using speaker recognition.

FIG. 12B shows a method for use in gaining access to a networked server using speaker recognition.

### DESCRIPTION OF THE PREFERRED EMBODIMENT(S)

The present invention uses speech recognition in combination with various security and communications systems and methods. As a result, an inventive, remotely accessible and fully automatic speech verification and/or identification system results.

1. Speech Recognition Unit.

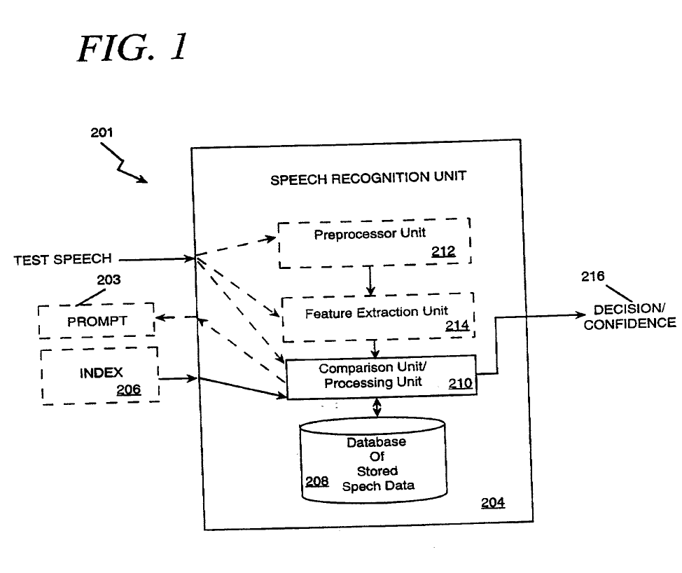

FIG. 1 illustrates a speech recognition system 201. Test speech 202 from a user is input into a speech recognition unit 204, which contains a database of stored speech data. A prompt 203 may be presented to the user to inform the user to speak a password or enter index information. In a speaker verification system, an index 206 is normally supplied, which informs the speech recognition unit 204 as to which data in the database 208 is to be matched up with the user. In a speaker identification system, an index 206 is normally not input, and the speech recognition unit 204 cycles through all of the stored speech data in the database to find the best match, and identifies the user as the person corresponding to the match. Alternatively, if a certain threshold is not met, the speech identification system 204 may decide that no match exists.

In either case, the speech recognition unit 204 utilizes a comparison processing unit 210 to compare the test speech 202 with stored speech data in a database 208. The stored speech data may be extracted features of the speech, a model, a recording, speech characteristics, analog or digital speech samples, or any information concerning speech or derived from speech. The speech recognition unit 204 then outputs a decision 216, either verifying (or not) the user, or identifying (or not) the user. Alternatively, the “decision” 216 from the speech recognition unit includes a confidence level, with or without the verification/identification decision. The confidence level may be data indicating how close the speech recognition match is, or other information relating to how successful the speech recognition unit was in obtaining a match. The “decision” 216, which may be a identification, verification, and/or confidence level, is then used to “recognize” the user, meaning to identify or verify the user, or perform some other type of recognition. Either verification or identification may be performed with the system 201 shown in FIG. 1. Should identification be preferred, the database 208 is cycled through in order to obtain the closest match.

Systems which may be used to implement the speech recognition system of FIG. 1 are disclosed in U.S. Pat. No. 5,522,012, entitled “Speaker Identification and Verification System,” issued on May 28, 1996, patent application Ser. No. 08/479,012 entitled “Speaker Verification System,” U.S. patent application Ser. No. 08/______, entitled “Model Adaption System And Method For Speaker Verification,” filed on Nov. 3, 1997 by Kevin Farrell and William Mistretta, U.S. patent application Ser. No. 08/______, filed on Nov. 21, 1997, entitled “Voice Print System and Method,” by Richard J. Mammone, Xiaoyu Zhang, and Manish Sharma, each of which is incorporated herein by reference in its entirety.

Referring to FIG. 1, the speech recognition unit 204 may contain a preprocessor unit 212 for preprocessing the speech prior to making any comparisons. Preprocessing may include analog to digital conversion of the speech signal. The analog to digital conversion can be performed with standard telephony boards such as those manufactured by Dialogic. A speech encoding method such as ITU G711 standard μ and A law can be used to encode the speech samples. Preferably, a sampling rate of 8000 Hz is used.

The preprocessor unit may perform any number of noise removal or silence removal techniques on the test speech, including the following techniques which are known in the art:

Digital filtering to remove pre-emphasis. In this case, a digital filter H(z)=1−αz⁻¹ is used, where α is set between 0.9 and 1.0.

Silence removal using energy and zero-crossing statistics. The success of this technique is primarily based on finding a short interval which is guaranteed to be background silence (generally found a few milliseconds at the beginning of the utterance, before the speaker actually starts recording).

Silence removal based on an energy histogram. In this method, a histogram of frame energies is generated. A threshold energy value is determined based on the assumption that the biggest peak in the histogram at the lower energy region shall correspond to the background silence frame energies. This threshold energy value is used to perform speech versus silence discrimination.

Additionally, the speech recognition unit may optionally contain a microprocessor-based feature extraction unit 214 to extract features of the voice prior to making a comparison. Spectral speech features may be represented by speech feature vectors determined within each frame of the processed speech signal. In the feature extraction unit 214, spectral feature vectors can be obtained with conventional methods such as linear predictive (LP) analysis to determine LP cepstral coefficients, Fourier Transform Analysis and filter bank analysis. One type of feature extraction is disclosed in previously mentioned U.S. Pat. No. 5,522,012, entitled “Speaker Identification and Verification System,” issued on May 28, 1996 and incorporated herein by reference in its entirety.

The speech recognition unit 204 may be implemented using an Intel Pentium platform general purpose computer processing unit (CPU) of at least 100 MHz having about 10 MB associated RAM memory and a hard or fixed drive as storage. Alternatively, an additional embodiment could be the Dialogic Antares card.

While the speech recognition systems previously incorporated by reference are preferred, other speech recognition systems may be employed with the present invention. The type of speech recognition system is not critical to the invention, any known speech recognition system may be used. The present invention applies these speech recognition systems in the field of security to increase the level of security of prior, ineffective, systems.

2. Security Methodology and Systems.

According to the present invention, speaker recognition can provide varying levels of security based upon customer requirements. A biometric, such as voice verification, confirms the actual identity of the user. Other prevalent high security methods, such as token cards, can still be compromised if the token card is stolen from the owner. With speaker recognition, the user need know only a single piece of information, what to speak, and the voice itself supplies another identifying piece of information. The present invention contemplates at least three levels of security, “simple” security, multi-tiered security, and randomly prompted voice tokens.

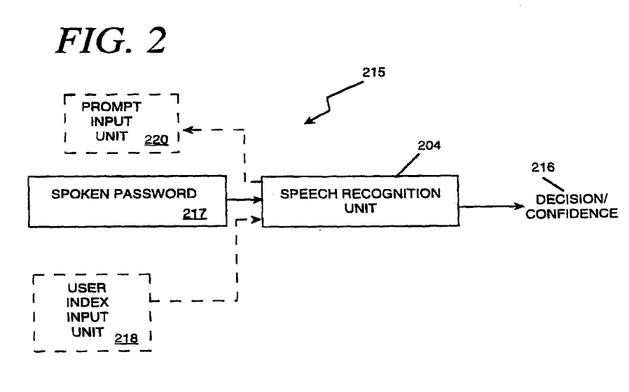

A more general depiction of a speaker recognition system 215 is shown in FIG. 2. As shown in FIG. 2, the user supplies a spoken password 217 to the speech recognition unit 204. The spoken password is preferably input into a microphone at the user's location (not shown) or in the speech recognition unit 204 (not shown). The password may also be obtained from a telephone or other voice communications device (not shown). In response to the spoken password, or subsequent data, the speech recognition unit 204 outputs a decision 216, which may be or include a confidence level. To increase the level of security, an optional user index input unit 218 may be included to obtain index information, such as a credit card number, social security number, or PIN. The user index input unit 218 may be a keyboard, card reader, joystick, mouse, or other input device. The index may be confidential or public, depending on the level of security desired. An optional prompt input unit 220 may be included to prompt the user for a speech password or index information. The prompt input unit may be a display, speaker, or other audio/visual device.

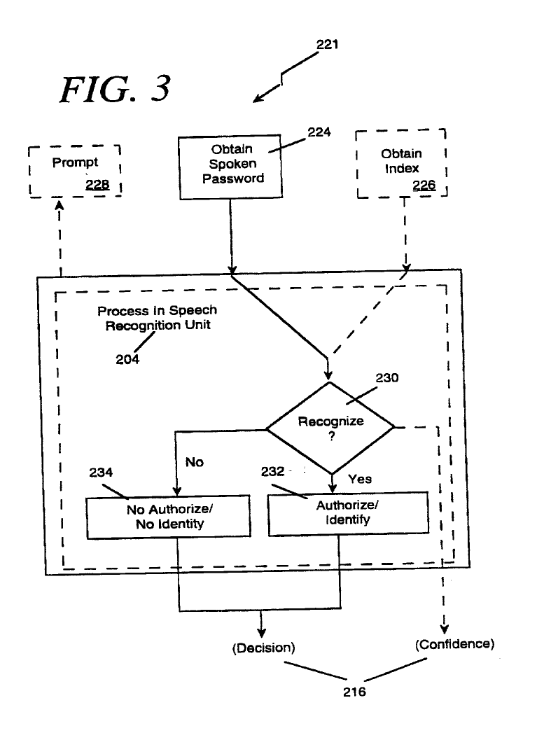

A “simple” security method 221 is shown in FIG. 3. This method may be implemented in the system of FIG. 1 or 2. The “simple” security system requires only the password and the voice biometric. This type of authentication provides a security level typical of today's token based systems. Thus, in FIG. 3, a spoken password 224 is obtained as well as optional index information 226. The password and index may be obtained from prompting 228 the user. This information is then processed in the speech recognition unit 204. The speech recognition unit 204 attempts to recognize 230 the speaker of the password (as belonging to the person identified by the index information, if entered). If the speaker is recognized, authorization is granted or the person is identified 232. If the speaker is not recognized, authorization is denied (i.e. not granted or a “no identity” result occurs 234). Optionally, the speech recognition unit's decision 216 is or includes a confidence level.

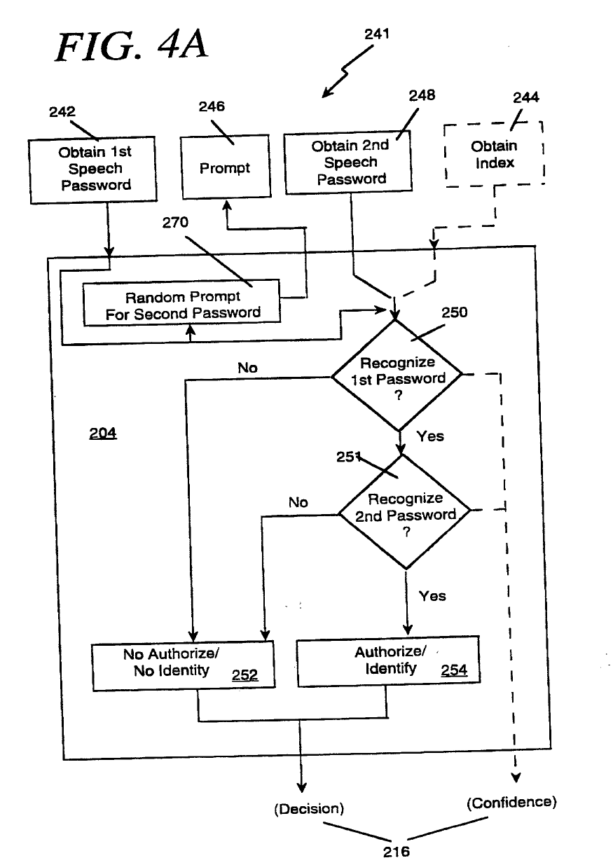

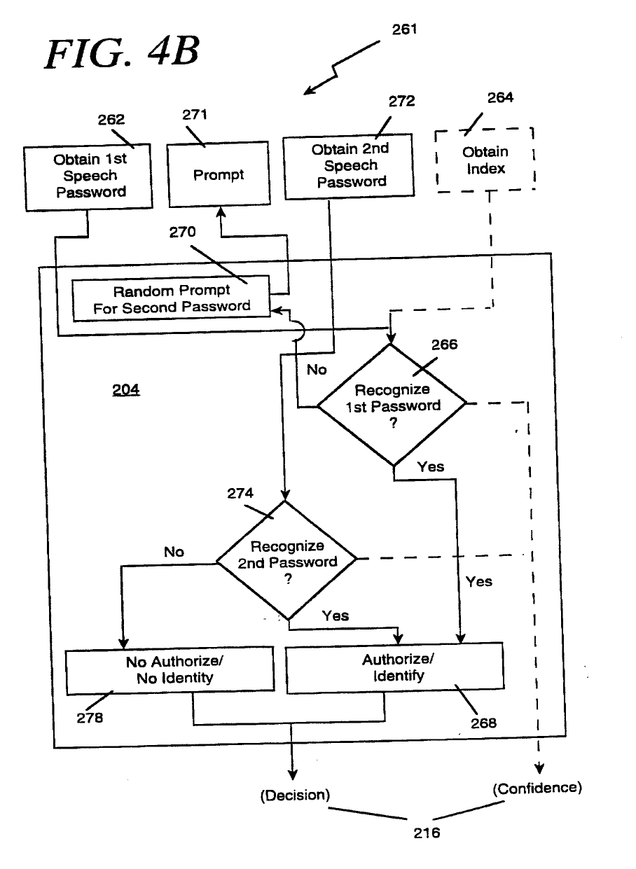

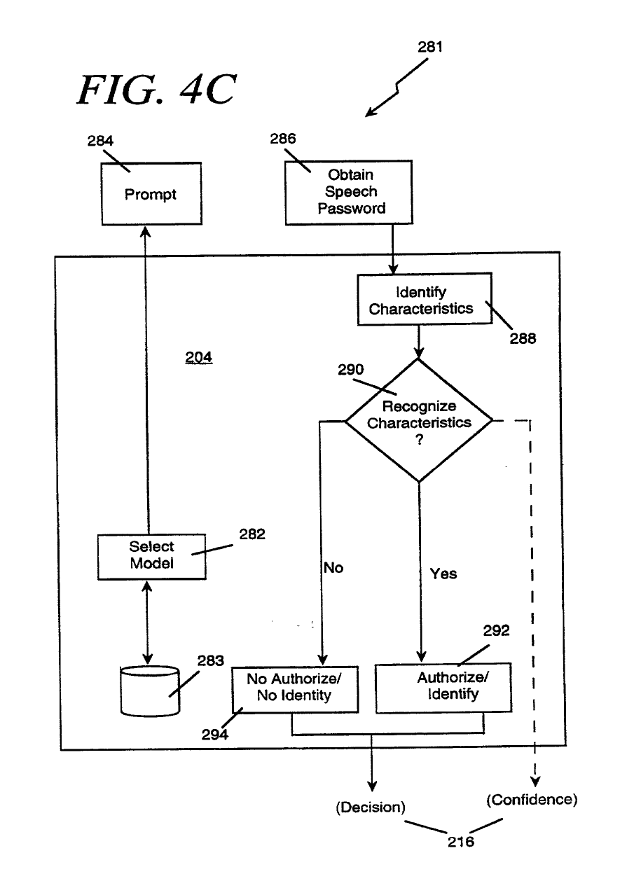

A Multi-tiered security flow diagram is shown in FIG. 4A. The FIG. 4A method may be implemented in the systems of FIG. 1 or 2. The method 241 shown in FIG. 4A employs multiple tiers of spoken passwords to enhance security even further. For instance, a user is required to speak their selected password as well as additional randomly prompted information that is currently used for authentication today, such as mother's maiden name, birth date, home town, or SSN. A multi-tier system adds randomness to the system to deter attacks through mechanisms such as digital recordings, as well as offers enhanced biometric validation. For example, if system performance typically authenticates with a 99.5% accuracy, a two tier system will authenticate at 99.9975%, and a three tier system at 99.999988%. Additionally, a multi-tier system checks both multiple pieces of knowledge and multiple biometric samples. Because speech is an easy to use, natural interface, the burden placed on the user for a multi-tier system will still be less then that of a token based system. This system can be language dependent or language independent.

As shown in FIG. 4A, a first speech password is obtained 242 from the user. Index information may also, optionally, be obtained 244 from the user. After receiving the first speech password and optional index information, the voice recognition unit 204 prompts 246 for a second (random) password 246. The prompt may be displayed by the prompt input unit 220 of FIG. 2. Next, the second speech password is obtained 248. The voice recognition unit 204 then determines whether it recognizes the first password 250. If the first password is not recognized, there is no authorization or identification 252. If the first password is recognized, the voice recognition unit determines whether it recognizes the second password 251. If the second password is not recognized there will be no authorization or identification 252. If the second password is recognized, authorization and/or identification will occur 254. Optionally, a confidence level is output as, or included in, the decision 216.

A two-tier system may be made conditional on rejection of a first password. FIG. 4B shows a conditional two-tier system 261. As shown in FIG. 4B, a first speech password is obtained 262. Optionally, index information is also obtained 264. The speech recognition unit 204 then determines whether it recognizes the first password 266. If the first password is recognized, authorization and identification will occur 268.

If the speech recognition unit does not recognize the first password, it generates a second (random) password 270. The second password is randomly generated by the speech recognition unit 204. A prompt for this password may be displayed 271 on a prompt input unit 220 (FIG. 2). The second speech password is obtained 272, and if the second password 270 is recognized 274, authorization or identification occurs 278. If the second password is not recognized, no authorization or identification takes place 268. Optionally, the decision 216 may comprise, or include a confidence level.

A randomly prompted voice token method 281 is shown in FIG. 4C. In a randomly prompted voice tokens system, the system models specific, discrete characteristics of particular spoken sounds, such as vowels. The system then randomly selects a word or phrase from a large database 283 of hundreds, or even thousands of words, and prompts the user to speak that word. The system then separates the particular characteristics of interest from that word and verifies against those characteristics. This gives a completely random word selection to achieve a high level of immunity against digital recordings and does not require the user to remember a password.

As shown in FIG. 4C, the speech recognition unit 204 selects a model 282 of specific discrete characteristics of particular spoken sounds from the database 283. The user is then prompted to speak a word or phrase containing information relating to the model, which may be prompted 284 by the prompt input unit 220 (FIG. 2). The speech password is then obtained 286. In this case, the speech password relates to the prompted speech characteristics.

After receiving the speech password 286, the voice recognition unit 204 identifies characteristics of the speech password 288. The voice recognition unit 204 then determines whether it recognizes these characteristics as consistent with those in the selected model of characteristics 290. If the characteristics are recognized, authorization and/or identification occur 292. If the characteristics are not recognized, no authorization or identification occurs 294. Optionally, a confidence level may be included in the decision 216.

The “simple” system, multi-tiered system and randomly prompted voice token system may be combined with each other in alternative embodiments. For example, a speech password and a randomly prompted voice token could be used together, in either single or multiple levels. Other types of current security systems of methodologies, either voice or non-voice, may be employed with the present invention, such as smartcard systems or password systems. The present invention adds the advantages of voice-recognition to known systems and methodologies.

3. Additional Embodiments

The present invention is useful in a number of embodiments, described in more detail below. The “simple” system, multi-tiered system, randomly prompted voice token system, and/or other systems may be used in combination with the embodiments presented below.

3.1 Speaker Recognition System/Service—General.

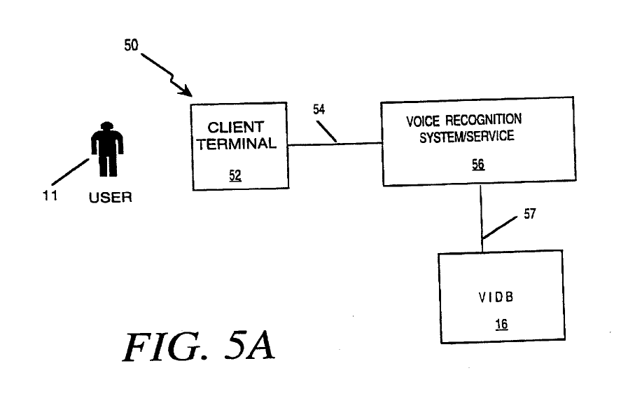

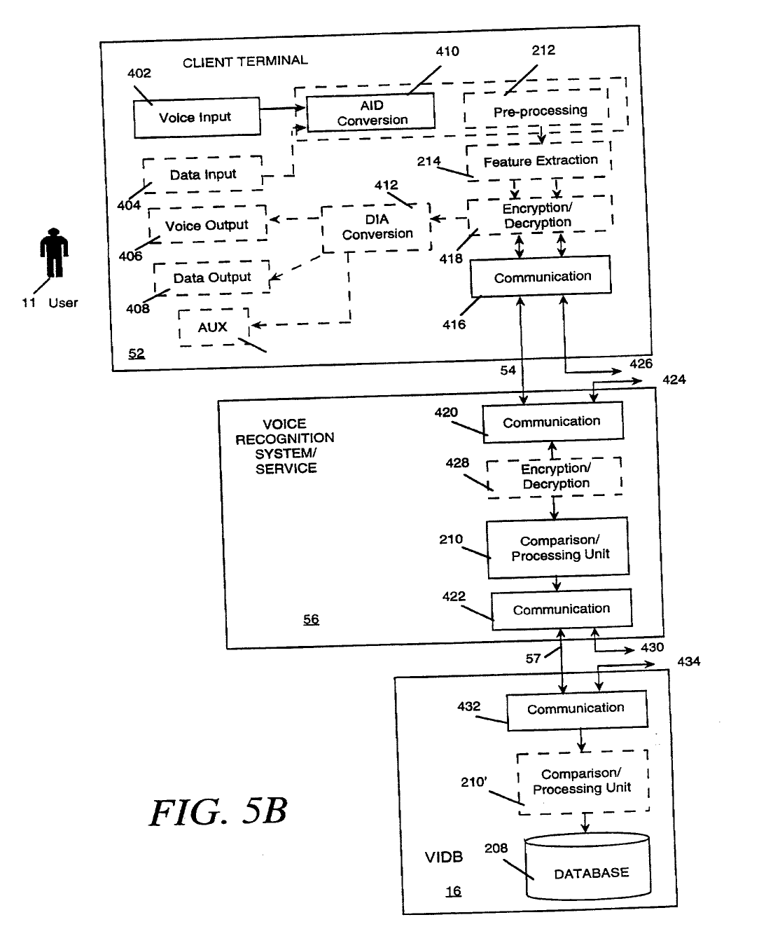

FIG. 5A illustrates a schematic diagram of a general configuration of a voice verification method and system 50. As shown in FIG. 5A, client terminal 52 is connected 54 to a voice recognition system/service 56. The connection 54 can be a voice connection (such a telephone connection), a data connection (such as a modem connection) or a combination of a voice connection and a data connection (such as an ISDN connection). The voice recognition system/service 56 establishes a link 57 with a voice identification database unit (VIDB) 16. The VIDB 16 stores information such as voice identities or voice prints.

If the connection 54 is a voice connection, the voice verification system 56 matches a voice sample from the client terminal 52 to a voice sample stored in the VIDB 16. If a data connection is established, a voice sample of the client is converted by client terminal 52 to data features at the client terminal 52's site. The data features sent over connection 54 are optionally encrypted. The voice recognition system/service 56 matches the data from user 52 with data stored in VIDB 16, to perform voice recognition on the user's voice.

FIG. 5B shows a more detailed description of the client terminal 52, voice recognition system/service 56, and VIDB 16, shown in FIG. 5A. The preprocessor unit 212 of FIG. 1 and the feature extraction unit 214 of FIG. 1 are included in the client terminal 52 of FIG. 5B. The comparison processing unit 210 of FIG. 1 is preferably included in the voice recognition system/service 56 of FIG. 5B, but alternatively may be provided in the VIDB 16 of FIG. 5B 210′. The database 208 of FIG. 1 is also preferably located in the VIDB 16.

The system of FIG. 5B further clarifies where the location of additional components are preferably installed. The client terminal 52 normally contains a voice input unit 402, data input unit 404, voice output unit 406 and data output unit 408. The voice input unit may be a microphone, which is used to provide analog voice signals to an A to D conversion unit 410. The data input unit 404 may be a keyboard or mouse, or card reader, which enables users to input data. The data may or may not require A to D conversion, the data input unit 404 is shown connected to the A to D convertor unit for purposes of clarity.

The voice output unit 406 is used to provide prompts and other information to the user. The voice output unit 406 may be a speaker or headphones. The data output unit 408 is used to provide data and/or prompts to the user. The data output unit 408 may be a cathode ray tube, LCD display, LED display or other visual indicator. Many types of data outputs require analog information, thus, a digital to analog convertor 412 is connected to the inputs of the voice output unit 406 and data output unit 408. An AUX unit 414 is also provided. The AUX unit 414 may be a switch or other device which is instructed to function upon the occurrence of a successful or unsuccessful verification or identification, or upon a certain confidence level. The AUX unit 414 may or may not require digital to analog conversion prior to operation.

The client terminal 52 is used to obtain voice input information and/or data input (such as index) information. This information may be directly provided to a communication unit 416 for transfer to the voice recognition system/service 56. However, preferably, the voice/data information is A to D converted (if necessary) and undergoes other preprocessing in the preprocessing unit 212. The preprocessing may occur as previously described with respect to FIG. 1. Also, following preprocessing, feature extraction occurs in a feature extraction unit 214. Feature extraction is used to extract digitized features of interest from the voice information and occurs as previously described with respect to FIG. 1. These extracted features are unintelligible and, therefore, the voice data cannot be compromised once the data leaves the client terminal.

After feature extraction, the information, preferably, is passed to an encryption/decryption unit 418. The encryption/decryption unit 418 digitally encrypts the information and allows for a secure transmission to the voice recognition system/service 56.

The communication unit 416 in the client terminal may be a telephonic communication device, modem, internet access line, cellular telephone, digital PCS transmitter or any known local or remote voice/data interface, including as known busses and interfaces.

The voice recognition system/service 56 contains a first communication unit 420, comparison processing unit 210 and second communication unit 422. The first communication unit 420 receives transmissions from the client terminal 52 or other sources. Communications transmissions are received from the client terminal 52 on line 54 and from other sources on line 424. The communication unit in the client terminal communicates to the voice recognition system/service on line 54 and to other sources on line 426.

The comparison/processing unit 210 performs the task of voice recognition by obtaining voice information from the database 208 in the VIDB 16. The comparison/processing unit 210 formulates a recognition decision 216 based on a comparison of the voice features of the user and the stored voice data from the database 208. Both speaker verification and speaker identification may be performed.

If the client terminal does not contain an A to D converter 410, preprocessor 212 or feature extraction unit 214, the voice recognition system/service 56 contains these components (not shown). The voice recognition system/service 56 also, preferably, contains an encryption/decryption unit 428. The encryption/decryption unit 428 is used to encrypt or decrypt information from the client terminal 52. The voice recognition system/service 56 communicates to the VIDB 16 through the second communication unit 422. The communication unit may also communicate to any other destination, including the client terminal 52 on line 430.

The VIDB 16 contains a communication unit 432 and database 208. Optionally, the VIDB contains a comparison/processing unit 210′. The comparison/processing unit 210′ is present in the VIDB only in the event that the voice recognition system/service 56 is utilized as a switching network to forward all incoming information to VIDB 16. The VIDB 16 may also contain a encryption/decryption unit (not shown), if the voice recognition system/service 56 communicates encrypted information to VIDB 16. However, it is assumed that communication line 57 between the voice recognition service and VIDB is secure, or that the VIDB 16 and voice recognition/service 56 are co-located. In this event, a secure transmission on line 57 would not be required.

The systems of FIG. 5A and FIG. 5B are useful for obtaining a voice and/or data input from a user, performing remote or local voice recognition, and communicating the success or failure of the recognition to the user. Voice recognition is performed at the voice recognition system/service 52, and the decision 216 of the recognition communicated to the user on the user's voice output 406 or data output. Alternatively, as shown in FIG. 5B, the decision of recognition 216 may be communicated by the voice recognition system/service 52 to a third party on line 430. As a further alternative, also shown in FIG. 5B, if the user is attempting entry to a system requiring recognition, the user's communication equipment may directly communicate the success or failure of recognition to the third party on line 426. As an even further alternative, shown in FIG. 5B, the VIDB may contain a comparison/processing unit and therefore directly communicate the recognition decision 216 to the client terminal 52 on line 434, voice recognition system/service 56 on line 57, or third party on line 434.

Other types of information may also be communicated between client terminal 52, voice recognition system/service 56, and VIDB 16. For example, information may be supplied by client terminal 52 to voice recognition system/service 56, and/or VIDB 16 as to where the recognition decision 216 should be communicated, and by which part of the system.

As one example, if a user 11 wishes to access a database (not shown), the user 11 provides a spoken password which is matched against a voice identity stored in VIDB 16. The voice recognition system/service 56 provides a decision to the user 11 as to whether or not his password was accepted or rejected as matching the stored voice identity in VIDB 16. This decision is then automatically communicated to the database provider via line 426. Alternately, the decision may be communicated on line 424 directly to the database provider if so indicated by client terminal 52. The database provider may be a service as for example provided by ORACLE or the like.

The security methods described previously, i.e. the “simple” system 221 of FIG. 3, the multi-tiered system 241, 261 of FIGS. 4A & 4B, and the randomly prompted voice token system 281 of FIG. 4C may be implemented in the voice recognition system/service. The spoken passwords are obtained via the voice input 402, the index information obtained via the data input 404 (if necessary) and the prompts communicated to the user via the voice output 406 or data output 408. Thus, for a general system, the embodiments of FIG. 5A and FIG. 5B are able to provide very high level of security.

3.2. Credit Card Validation.

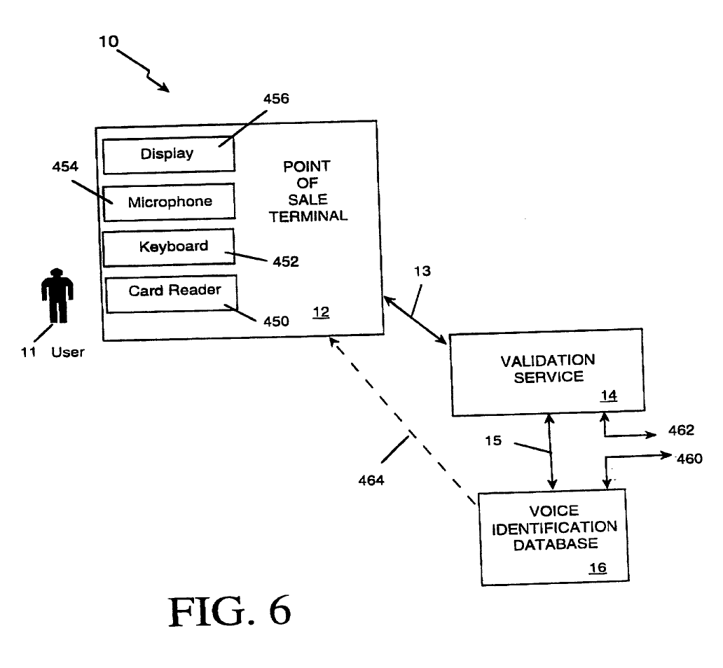

FIG. 6 illustrates a schematic diagram of the voice recognition method and system of the present invention for a credit card validation system 10. In the credit card validation system 10, a user 11 is validated at point of sale terminal 12, located at a point of sale. The point of sale terminal 12 may be constructed as shown in FIG. 5B with respect to the client terminal 52. In this case, the credit card number is read by a card reader 450. Other information, such as the price of the item(s) the user seeks to purchase may be entered by a keyboard 452. A spoken password is entered by the user into a microphone 454. The card reader 450 and keyboard 452 correspond to the data input 404 of FIG. 5B, and the microphone 454 corresponds to the voice input 402. The credit card number, other related information (if present), and spoken password are transmitted to the validation service 14 over a conventional link 13, such as a telephone line. The validation service 14 may be constructed as shown in FIG. 5B with respect to the voice recognition system/service 56.

The validation service 14 establishes a conventional link 15 with a voice identification database (VIDB) 16. The voice identification database (VIDB) 16 may be constructed as shown in FIG. 5B. The VIDB 16 receives account information from validation service 14 in order to index a stored voice identity or voiceprint corresponding to the account information. Additionally, the VIDB 16 may contain account data in its database (not shown) to verify that the user's account is valid and will not be exceeded by the requested purchase. Alternatively, the VIDB 16 or validation service 14 may communicate to an external credit bureau over lines 460, 462, respectively, to confirm that the user's account is valid and is not going to be exceeded by the requested purchase.

The validation service 14 performs speaker recognition on the spoken password to determine whether the spoken password matches the speech data stored in the database for the person identified by the index information. The validation service 14 may also obtain credit bureau results, as previously discussed.

The validation decision 216 and credit bureau results (if present) are forwarded via link 13 back to the point of sale terminal 12. Alternatively, the decision is forwarded via a direct connection 464 between VIDB 16 and point of sale terminal 12, if the comparison/processing unit 210′ is located in VIDB 16. The point of sale terminal has a display 456 corresponding to the data output 408 of FIG. 5B. The display 456 informs the merchant as to whether the user is authorized, whether the user has exceeded the maximum on the credit card account, and/or whether the credit card is valid.

Preferably, a preprocessor unit, a feature extractor unit, and a encryption/decryption unit (not shown) are used in the point of sale terminal 12 in the credit validation system 10. These components function as previously described with respect to FIG. 5B.

The security methods described previously, i.e. the “simple” system 221 of FIG. 3, the multi-tiered system 241, 261 of FIGS. 4A & 4B, and the randomly prompted voice token system of FIG. 4C may be implemented in the credit validation system 10. The spoken passwords are obtained via the microphone 454, the index information obtained via keyboard 452 and the prompts communicated to the user via the display 456. Thus, the present invention is able to significantly improve the security provided over prior art credit card validation systems.

3.3. Home Authorization to Call Center.

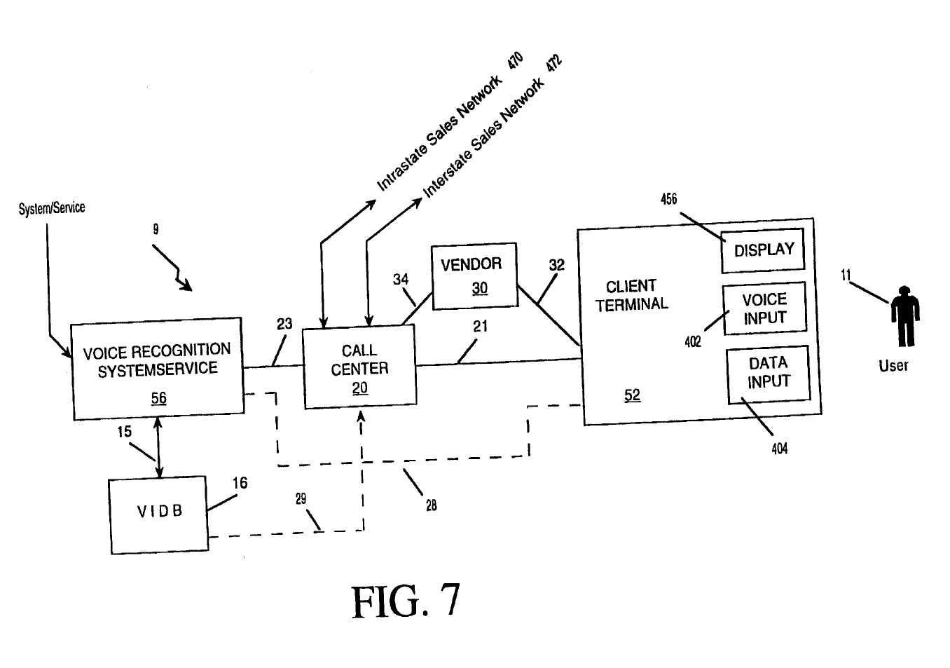

In another embodiment, shown in FIG. 7, a user 11 can establish a connection 21 between a client terminal 52 and a call center 20 to provide home validation of credit card transactions. In system 9 shown in FIG. 7, the client terminal 52 is constructed as previously shown and described in FIGS. 5A and 5B.

Referring back to FIG. 7, the client terminal 52 can connect from the home via telephone line 21 to a call center 20, which is connected to intra-state sales networks 470 and inter-state sales 472 networks. The user 11 provides account information (which may be used as index information) via a data input unit device, for example a keyboard, and a voice identity password via a voice input unit 402, for example a microphone, to the client terminal 52. A display 456 is used for showing decisions or prompts. The client terminal 52 connects to call center 20 via telephone line 21, or another standard link. The call center 20 passes the voice and index information (if present) to the voice recognition system/service 56 over a standard link 23, which may be a telephone line.

The voice recognition system/service 56 may be constructed as previously described with respect to FIGS. 5A and 5B. After receiving the voice and index information (if present), the voice authorization service 56 requests voice data from the voice information database unit 16 (VIDB). The VIDB may be constructed as shown and described with respect to FIGS. 5A and 5B.

An optional connection 28 may be established between the voice recognition system/service 56 and the user's terminal 52 for providing results on the display as to whether or not the user 11 is accepted or rejected by the voice recognition system/service 56. Another alternative connection 29 may be established between the VIDB 16 and the call center 20, should the VIDB contain the comparison processing unit 210′ shown in FIG. 5B.

From a marketing standpoint, profiling of users 11 for buying preferences and the like can be provided either at voice recognition system/service 56 or at VIDB 16.

In another alternative embodiment, a the client terminal 52 may connect to call center 20 via a vendor retail service bridge 30. The client terminal 52 can establish connection 32 with vendor retail bridge 30 either as a telephone connection or a modem connection to a vendor retailer computer in vendor retail service bridge 30. The vendor retail service bridge 30 connects to the call center 56 over a link 34 for receiving the decision 216 of whether or not to accept or reject the user 11. The decision 216 from the voice recognition system/service 56 is forwarded via link 23 to the call center 20, and may subsequently be forwarded via link 21 to the client terminal 52 or may be forwarded via link 30 to the vendor retail service bridge 30.

Preferably, a preprocessor, a feature extractor, and an encryptor (not shown) are used in the client terminal 52 of the home call center embodiment. These components function as previously described with respect to FIG. 5B.

The security methods described previously, i.e. the “simple” system 221 of FIG. 3, the multi-tiered system 241/261 of FIGS. 4A & 4B, and the randomly prompted voice token system 281 of FIG. 4C may be implemented in the call center embodiment 9. The spoken passwords are obtained via the voice input 402, the index information obtained via the data input 404, the prompts communicated to the user via the display 456. Thus, call centers may be provided with heightened security using the principles of the present invention.

3.4. Telephone Call Verification/Identification.

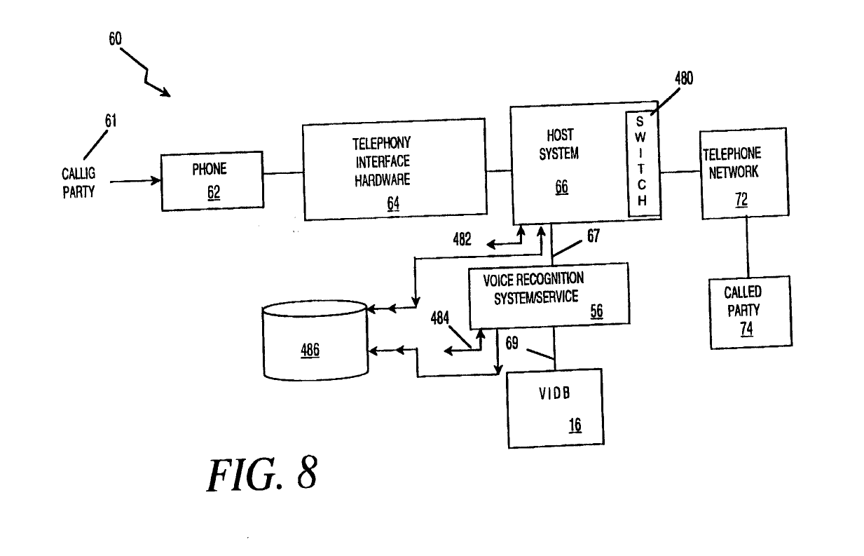

FIG. 8 illustrates the voice recognition method and system 60 of the present invention for establishing a call to a called party using a telephone network 12. This application is particularly advantageous for establishing security for calls from prison inmates to parties outside the prison system. Certain prison inmates may be denied telephone privileges, and the present system ensures that these inmates cannot make telephone calls to a called party.

In the embodiment of FIG. 8, the calling party 61, who may be a prison inmate, uses a phone instrument 62 to access telephony interface hardware 64. The telephony interface hardware 64 connects to a host system 66. The host system 66 establishes a connection 67 with the voice recognition system 56.

A voice sample of calling party 61 is passed from the telephone 62 to the telephony interface hardware 64 through host system 66 to voice recognition system/service 56. The voice sample can be either voice or data of the voice sample created at host system 66.

In this embodiment, the host system 66 contains the elements of the client terminal 52 shown in FIG. 5B, using a switch 480 as the AUX unit 414. The host system 66 establishes a link 67 with the voice recognition system/service 56. The voice recognition system/service 56 is preferably constructed as shown in FIG. 5B. The voice recognition system/service 56 establishes link 69 with VIDB 16 to index (if index data is present) a stored voice identity or voice print of calling party 61. The index data may be manually entered by the prisoner or calling party 61 via touch-tones at the onset of the telephone call.

The voice recognition system/service 56 makes a decision 216 whether or not to accept or reject calling party 61. This decision 216 is communicated to the host system 66, which establishes a connection 70 to the telephone network 72 via the switch 480 if the decision is positive. Thereafter, telephone network 72 establishes a connection to the called party 74 to enable communications with the calling party 61.

Either the host system 66 or the voice recognition system 56 may be connected to a credit bureau via lines 482, 484 to ensure that the calling party has sufficient credit to complete the call. Further, the host system 66 or the voice recognition system 56 may be connected to a prison database 486 to determine whether the identified/authorized caller has calling privileges generally, or is blocked from the specific dialed number. The prison database 486 could alternatively be included within the VIDB unit 16.

The security methods described previously, i.e. the “simple” system 221 of FIG. 3, the multi-tiered system 241, 261 of FIGS. 4A & 4B, and the randomly prompted voice token system 281 of FIG. 4C may be implemented in the called party system 60. The spoken passwords are obtained via the telephone 62, the index information obtained via touch-tone or rotary dialing, and the prompts communicated to the user via a voice output 406 using speech or audible tones.

Therefore, in order for a prisoner to make a call, index (if desired) and a voice password must be communicated to the host system 66. If voice recognition does not occur, and if the proper access criteria are not present, the switch will not be opened and the call will not be allowed to proceed. Thus, by updating a database 486, prison officials can control the ability of prisoners to make telephone calls.

3.5. Internet Access.

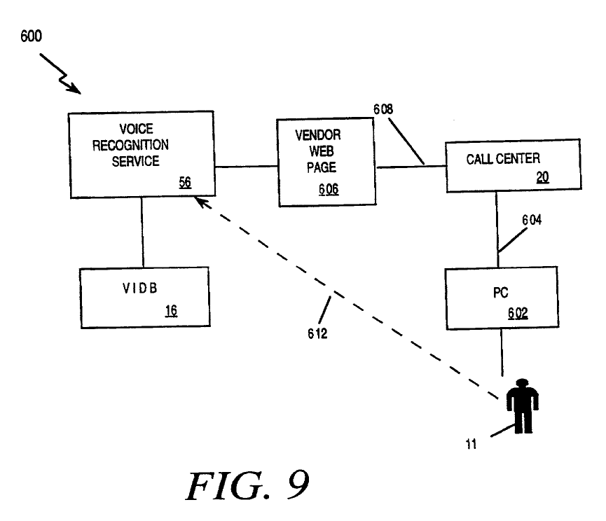

FIG. 9 is a schematic diagram of the voice recognition method and system 600 of the present invention for use in establishing an internet connection. The user 11 provides a voice sample to a PC 602, configured as shown in FIG. 5B with respect to client terminal 52. Alternatively PC 602 may be web television configured as shown in FIG. 5B with respect to client terminal 52.

The PC 602 communicates via internet access link 604 to a call center 20. The vendor call center 20 establishes connection 608 to vendor web page 606 which provides access to the voice recognition system/service 56. The voice recognition system/service 56 is configured as shown in FIG. 5B.

In operation, the user 11 provides a spoken password to PC 602. Preferably, PC 602 includes a voice input (i.e. microphone), preprocessor, feature extractor and encryption (not shown). Additionally, the user may provide a digital identification for use as index information. The digital identification may be a secret key assigned to the internet user. For example, a digital identification that can be used in the present invention is the “Digital ID” manufactured by VeriSign of Mountain View Calif., U.S.A.

The voice and index information is communicated to call center 20, and forwarded via line 608 to the vendor web page 606, and then to the voice recognition system/service 56. The recognition decision 216 is then forwarded by the voice recognition system/service 56 to the vendor web page 606, and over link 608 to the call center 20. Thus, the vendor web page is informed as to whether the user is verified or identified. The call center 20 may notify the PC 602 as to the decision 216.

Alternatively, the user 11 provides a spoken password over a separate connection 612 to voice recognition system/service 56. In such a case, the voice recognition system/service contains the voice input (i.e. microphone), preprocessor and feature extractor shown in FIG. 5B. The recognition decision 216 is still forwarded by the voice recognition system/service 56 to the call center 20, and over link 608 to the vendor web page.

Other alternative links of communication may occur. For example, if the comparison processing unit of FIG. 5B is located in VIDB 16, a link (not shown) may be established between VIDB 16 and PC 602, call center 20, or vendor web page 606.

The security methods described previously, i.e. the “simple” system of FIG. 3, the multi-tiered system 241, 261 of FIGS. 4A & 4B, and the randomly prompted voice token system 281 of FIG. 4C may be implemented in the internet access embodiment 200. The spoken passwords and index information are obtained via the PC 602. The PC 602 also displays the prompts shown in FIGS. 3, 4A, 4B, and 4C.

Therefore, internet access can be made very secure in order to increase the faith of internet providers that only authorized users are using their access systems.

3.6. Electronic Commerce.

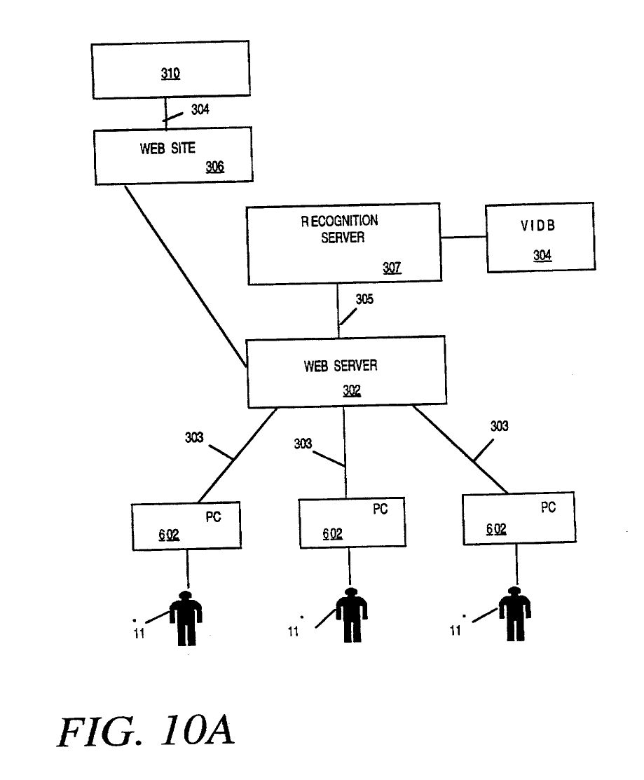

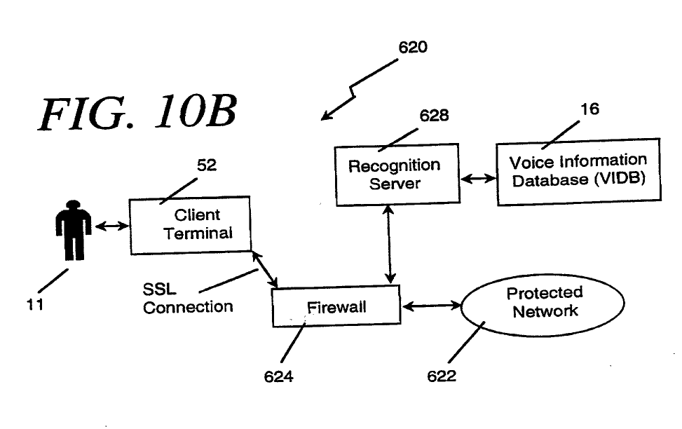

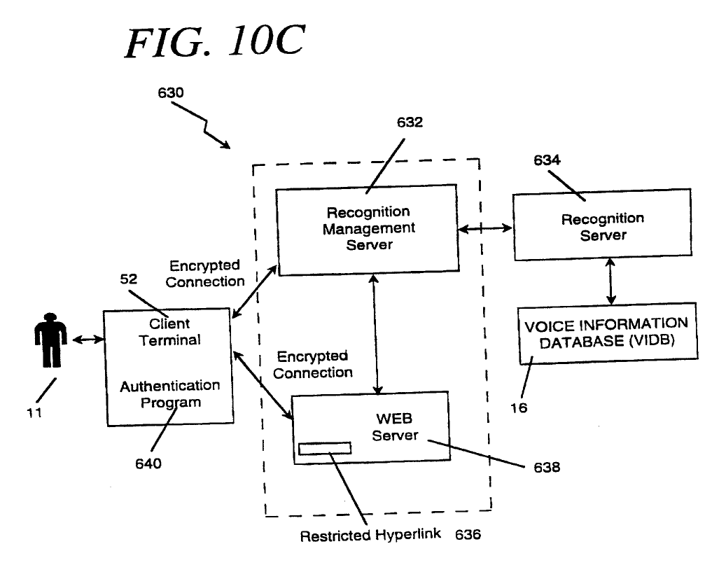

FIGS. 10A, 10B, and 10C illustrate a schematic diagram of a verification method and system 300 of the present invention for application in a world-wide-web environment. Speaker verification technology can be implemented in several different ways to secure access and transactions in the internet environment, and at several different levels. These include:

Securing transactions by enabling an existing standard such as Secure Electronic Transactions (SET) or Certificate of Authority (CA) to support voice biometrics. This is done through embedding the voice model or a reference to the voice model within the certificate or message.

Add support for voice biometrics to firewall products, which can then restrict access at periphery of the protected network to voice authenticated users. Add support to WEB server security features to support voice passwords in addition to typed passwords to restrict access to a WEB site.

A voice protected hyperlink that restricts access to certain areas of a WEB site to voice password enabled users. This could be done through a control, such as a JAVA applet or ActiveX control, that acts as the hyperlink after verifying a user.

Create a proprietary transaction interface to secure a transaction such as making a purchase on a WEB site.

With respect to FIG. 10A, users 11 operate PC's 602. PC's 602 are configured as the client terminals shown in FIG. 5B. The users provide a spoken password to PC's 602. The PC's 602 can include a series of distinctive tones to prompt a user to perform specified actions, such as prompting the user to speak his password. The distinctive tones can be used to replace conventional prompts of PC's 602.

The PC's 602 preferably include a preprocessor, feature extractor, and encryptor (not shown). The encrypted speech features 303 are then communicated to web server 302. The encrypted speech features 303 are decrypted by the web server 302 with a key stored in the web server 302. The web server 302 communicates over connection 305 with a recognition server 307. The recognition server 307 is constructed as shown in FIG. 5B with respect to the voice recognition system/service 56.

The recognition server 307 establishes a link with VIDB 304 and obtains a decision 216 as to whether or not user 11 is accepted or rejected. The decision is communicated on link 305 to the web server 302. If a user 11 is accepted, the web server allows access to the web site 306. Alternatively, the web server may establish a connection and access to another (protected) web server to host a protected site (not shown). The access allows a user 11 to have obtain to stored information or to establish a transaction. For example, the user can establish access to: a database used for storing information related to a user's 401 (k) account; to an investment application for placing orders to buy or sell mutual funds or stocks, or to an information service to access a mail order application for purchasing retail items and the like.

As shown in FIG. 10B, a firewall system 620 can be modified to function in accordance with the present invention. When a user at a client terminal 52 attempts to access a protected network 622 across the Internet, the connection first must pass through a firewall 624. The firewall 624 performs checking at various levels to ensure the validity of the attached users, both at initial access and during operation, to ensure the integrity of the connection is maintained an not used maliciously. Typical authentication methods at initial access are a log ID/password or a challenge/response token based system.

Speaker verification is a more robust mechanism to ensure the authenticity of the actual accessing user, and is not a piece of knowledge that can be easily compromised, or a token generating card that can be stolen. The client terminal 52 of FIG. 10B is preferably configured as the client terminal 52 shown in FIG. 5B. A recognition server 628 is preferably configured as the voice recognition system/service 56 of FIG. 5B, and the VIDB 16 is preferably configured as in FIG. 5B.

With reference to FIG. 10B, at initial access from the client terminal the user is prompted to say their password. This may be done through an Active X control or an applet if the user is accessing through a browser using the HTTP protocol. At the client terminal the speech data is optionally reduced to a feature set and then sent across an encrypted connection, such as a Secure Socket Layer (SSL) connection, to the firewall.

The firewall passes the data to the recognition server 628, along with the user's log ID. The recognition server 628 retrieves the model from the VIDB for that user and compare the speech data to the stored model. If the user is recognized, the firewall 624 permits the connection to be established, otherwise the user is denied access.

The firewall 624 also protects against internal users bringing in malicious data or programs from locations outside the protected network. Speaker verification may also be used to restrict external network access to authorized users.

FIG. 10C shows a voice protected hyperlink system 630. As shown in FIG. 10C, a client terminal 52, recognition management server 632, recognition server, and VIDB 16 are the key components to the system for granting access to a restricted hyperlink 636 at a web server 638. The client terminal 52 is preferably configured as shown in FIG. 5B, and is running an authentication program 640. The recognition server 634 is preferably configured as the voice recognition system/service 56 of FIG. 5B, and the VIDB 16 is preferably configured as in FIG. 5B.

With continued reference to FIG. 10C, a client at a client terminal browsing a web site selects a hyperlink 636 that is voice protected. Rather than going immediately to the hyperlinked location, an authentication program 640, such as a JAVA applet or ActiveX control, is launched at the client terminal through the client's browser. The authentication program 640 requests the user to enter an identifier, such as their name or account number. The identifier is used as index information for verification.

The authentication program 640 at the client terminal 52 then requests the recognition management server 632 to validate the user identifier, and if the identifier is valid requests the user to speak their pass phrase. The authentication program 640 then records the user speaking their pass phrase. An optional feature extraction may be performed by the program to reduce the data set requiring transfer and to make the speech unintelligible. The speech information is then passed from the authentication program 640 to the recognition management server 632, which passes it to the recognition server 634 for processing, with an optional security level.

The recognition server 634 compares the speech data to the retrieved voiceprint model for the user, and passes a decision or the results of the comparison back to the recognition management server 632. If the user is authenticated, then the server 632 passes the name of the protected hyperlink back to the authentication program 640 on the client terminal 52. The authentication program 640 then instructs the browser to access the restricted hyperlink 636 at the web site 638.

The security methods described previously, i.e. the “simple” system 221 of FIG. 3, the multi-tiered system 241. 261 of FIGS. 4A & 4B, and the randomly prompted voice token system 281 of FIG. 4C may be implemented in the internet security embodiments of FIGS. 10A, 10B, and 10C. The spoken passwords and index information are obtained via the PCs 602 or client terminals 52. The PCs 602 or client terminals 52 also display or indicate via audio means, the prompts shown in FIGS. 3, 4A, 4B, and 4C.

Therefore, the security of electronic commerce can be greatly increased to improve the ability of users to obtain information, products and services via the internet.

3.7. PC Security.

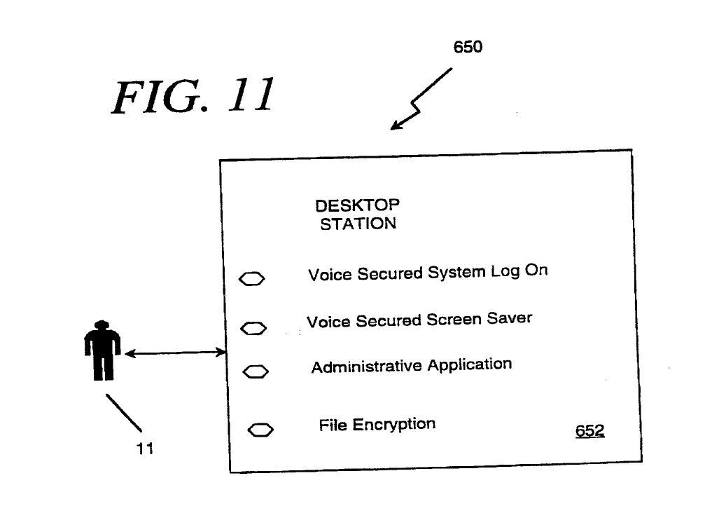

FIG. 11 shows a desktop security system 650. The desktop security system 650 is locally stored in a desktop station 652. In this embodiment, all the elements of FIG. 5B are included in the desktop station, and the communication units are all local interfaces.

Several components may be included in a desktop station to provide voice biometric protection, including:

Voice secured system login. A login prompt replaces the existing security, if any, on a desktop station. This login requires a voice biometric authentication before allowing access to the system.

A voice secured screen saver de-activation. This ensures that the station is locked after idling for an extended period and can only be accessed by a valid user. A hot-key activation could also immediately activate voice password protection without waiting for screen saver activation. This logic invokes the voice login when deactivating the screen saver. It only permits de-activation once a valid spoken password is received.

An administrative application for configuring user profiles and enrolling users in the system.

File Encryption (optional). This system encrypts files that can only be accessed through a spoken passphrase. The key for the file encryption could be derived from the spoken password, which adds a particular high level of security for documents accessed by a single person but prohibits sharing of encrypted document. Alternatively after an authentication the key could be looked up in an encrypted database for that file, or derived from information about the file, and then used for decryption.

The security methods described previously, i.e. the “simple” system 221 of FIG. 3, the multi-tiered system 241, 261 of FIGS. 4A & 4B, and the randomly prompted voice token system 281 of FIG. 4C may be implemented in the desktop station embodiment. The spoken passwords and index information are obtained via the desktop station. The desktop stations also display or indicate via audio means, the prompts shown in FIGS. 3, 4A, 4B, and 4C.

These security precautions help ensure that only the authorized user of a desktop station gains access to the desktop station and/or its files.

3.8. Network Security.

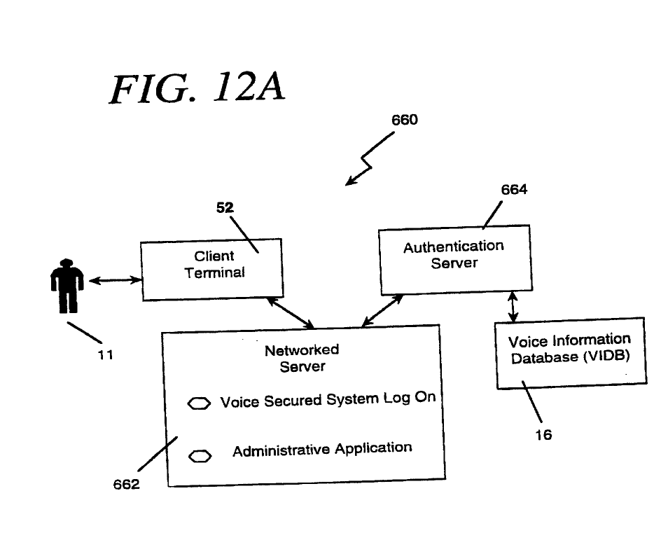

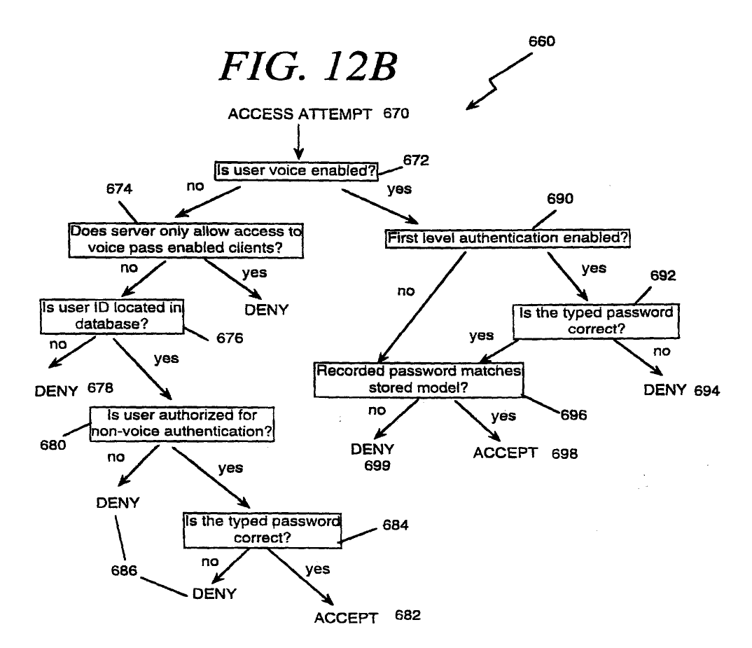

FIGS. 12A and 12B show a network security embodiment 660. FIG. 12A shows a network installation, including a user, client terminal 52 (such as a PC), networked server 662, authentication server 662 and VIDB 16. The client terminal is preferably configured as shown in FIG. 5B. The authentication server 664 is preferably configured as the voice recognition system/service 52 shown in FIG. 5B. The VIDB is preferably configured as shown in FIG. 5B.

Major predominant network servers have built in security mechanisms, typically through a login name/password, to limit access to server resources. These servers include Windows NT, NOVELL, and UNIX based systems. As strategies to attack these systems are becoming more sophisticated, the need for an alternative approach becomes evident. Voice biometrics provides a sophisticated mechanism much more difficult to compromise then typical server authentication methods.

The following features may be integrated into the network server security system and method:

Voice secured server login. A login prompt replaces the existing security, if any, for server access. Typically servers require a login name/password in order to access server resources. The server also typically assigns a set of privileges and access rights to a given user. The biometric login replaces the password login The underlying security model is still relied upon to provide access control to system resources once a user has logged on.

An administrative application for configuring user profiles and enrolling users in the system. Typically the administration will integrate into the existing server tools, unless the particular operating system of the server disallows tool modification.

As shown in FIG. 12B, the server security system 660 can operate in a mode where only users with voice passphrases are allowed to access a server, or a mixed mode where some users logging in through conventional password means can also gain access at reduced or equal security levels. User and security administration integrates as seamlessly as possible into the standard operating system management features; for instance, under Windows NT, the look and feel of the domain user and server manager programs are maintained.

With reference to FIG. 12B, when the user attempts to access the networked server 670, they are prompted for a conventional login name/password prompt to gather the user identification information at the client terminal. The client terminal sends the user information to the networked server. The network server makes a determination based upon the user identification whether the user is voice password enabled 672.

If the user is not voice password enabled and the server is configured to only allow access to voice pass enabled clients, or if the user ID is not located in the user database 676, then the login is denied 678. If the server is not configured to only allow access to voice pass enabled clients, and if this user's ID is located in the database 676, then the user's authorization is examined 680.

If this user is authorized for non-voice authorization 680, then the server allows the user access 682 if the typed password matches 684 the password stored in the user database for that user ID. If one of these first two conditions are not met, then the server will deny authentication.

Referring back to the access attempt 640 of FIG. 12B, if the user is voice enabled, the system may optionally use a conventional password to provide first level authentication 690. If first level authentication is enabled, the system performs first level authentication to check the user's password 692. If the password is not correct, access is denied 694, and if the password is correct, matching between the stored model and the recorded password is performed 696.

Matching between the stored model and the recorded password is also performed if first level authentication 690 is not enabled. Upon deciding to proceed with the matching 696, the client terminal prompts the user to say their spoken password. At this point feature extraction may optionally take place at the client on the speech data to reduce the data size and to put it into a format that is not intelligible to external applications. The speech data or features may then be encrypted and time stamped, then conveyed to the networked server 662. The networked server passes this information to the authentication server with an optional security level specified to indicating the severity of threshold to apply when making the biometric authentication.

The authentication server 664 retrieves a model of the spoken password from the VIDB 16 and compares data from the spoken pass phrase with the model, providing a binary result and optionally a confidence level.

The network server 662 then uses this authentication level to decide whether the recorded password matches the stored model to an acceptable degree. If the degree of matching is acceptable, access is allowed 698, otherwise access is denied 699. A configurable number of re-attempts will be permitted. If the number of allowed re-attempts is exceeded, then the server disables the account.

We claim:

1. A system for recognizing a user through speech recognition, comprising:
a client terminal, comprising:
a voice input, which obtains speech data; and
a first communication unit, connected to the voice input, which transmits information concerning the speech data;
a voice recognition system, operably connected to receive user information from a voice information database, comprising:
a second communication unit for receiving the information concerning the speech data from the first communication unit; and
a processing unit for providing output information concerning voice recognition between the input speech data and the user information from the voice information database.

2. The system of claim 1, wherein the client terminal further comprises:
a preprocessor connected to the voice input;
a feature extraction unit, connected to the preprocessor and to the first communication unit, wherein the feature extraction unit extracts the information concerning the speech data, and
wherein the processing unit utilizes the extracted information concerning the speech data.

3. The system of claim 1, wherein the first communication unit can receive output information, wherein the voice recognition system transmits output information to the client terminal, and the client terminal contains an output unit for indicating the output information.

4. The system of claim 1, wherein the output unit is a display and wherein the input unit is a microphone.

5. The system of claim 2, wherein the client terminal is a point of sale terminal, and wherein the first and second communication units are connected by a telephone line.

6. The system of claim 2, wherein the first and second communication units are connected by a call center.

7. The system of claim 2, wherein the call center is connected to the first communication unit by a vendor retail service bridge.

8. The system of claim 1, wherein the voice input is a telephone input, the first communication unit can receive output information, the voice recognition system transmits output information to the client terminal, and wherein the client terminal contains a switch which connects a telephone network to the telephone input upon successful voice recognition.

9. The system of claim 8, wherein the telephone input is connected to a telephone set located in a prison.

10. The system of claim 2, wherein the client terminal is a personal computer, wherein the first and second communication units are connected through a vendor web page and a call center, and wherein the vendor web page provides the personal computer with internet access in the event of successful voice recognition.

11. The system of claim 2, wherein the first and second communication units are connected through a firewall, and wherein the firewall provides the client terminal with access to a protected network in the event of successful voice recognition.

12. The system of claim 2, wherein the first and second communication units are connected through a web server and recognition management server, and wherein the recognition management server provides the client terminal with access to a restricted hyperlink in the event of successful voice recognition.

13. The system of claim 1, wherein the first and second communication units are interfaces on a desktop computer, and wherein the entire system is located on the desktop computer.

14. The system of claim 2, wherein the client terminal is a client terminal, wherein the first and second communication units are connected through a networked server, and wherein the network server provides the client terminal with access to a protected network in the event of successful voice recognition.

15. The system of claim 14, wherein successful voice recognition includes first level authentication.
